(19) United States
(12) Patent Application Publication
(10) Pub. No.: US 2006/0273285 A1
(43) Pub. Date: Dec. 7, 2006

(54) Method for controlling the size of fluoride nanoparticles

(76) Inventors: Changzai Chi, Hockessin, DE (US); Daniel Albert Green, Moylan, PA (US); Kurt Richard Mikeska, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/445,528

(22) Filed: Jun. 2, 2006

Related U.S. Application Data
(60) Provisional application No. 60/687,416, filed on Jun. 3, 2005.

(51) Int. Cl. C09K 11/61; C09K 11/08

(52) U.S. Cl. 252/301.4 H

(57) ABSTRACT

A method wherein an aqueous solution of a fluoride, an aqueous solution of a host multi-valent metal salt and, optionally, an aqueous solution of a rare-earth metal dopant form a precipitate and wherein increasing the concentration of at least one of the group selected from the aqueous solution of the fluoride or the host multi-valent metal salt within the concentration range achieves smaller particles; or wherein decreasing the concentration of at least one of the group selected from the aqueous solution of the fluoride or the host multi-valent metal salt within the concentration range achieves larger particles.

### FIELD OF THE INVENTION

The present invention provides a method for controlling the size of multi-valent metal fluoride nanoparticles formed in an aqueous process. The method is applicable to both rare-earth-doped and undoped multi-valent metal fluorides.

### BACKGROUND OF THE INVENTION

Several references describing methods for controlling the size of flouride nanoparticles follow. Bender et al., Chem. Mater. 2000, 12, 1969-1076, discloses a process for preparing Nd-doped BaF₂ nanoparticles by reverse microemulsion technology. Bender expressly states that aqueous salt solutions such as 0.06 M Ba⁺², produce particles smaller than 100 nm while concentrations of about 0.3 M Ba⁺² resulting in particles larger than 100 nm. Luminescing particles are disclosed. Bender discloses a decrease in lattice parameter for BaF₂ nanoparticles doped with Nd.

Wang et al., Solid State Communications 133 (2005), 775-779, discloses a process for preparing 15-20 nm Eu-doped CaF₂ particles in ethanol. Wang expressly teaches away from employing an aqueous reaction medium.

Wu et al., Mat. Res. Soc. Symp. Proc. 286, 27-32 (1993) disclose that CaF₂ particles produced by a vapor phase condensation process are characterized by an average particle size of 16 nm while Ca_{0.75}La_{0.25}F_{2.25} particles prepared by the same process were characterized by average diameter of 11 nm.

Stouwdam et al., Nano Lett. 2(7) (2002), 733-737, discloses synthesis of rare-earth doped LaF₃ in ethanol/water solution incorporating a surfactant to control particle size. The resultant produced incorporates the surfactant. 5-10 nm particles are prepared.

Haubold et al., U.S. Patent Publication 2003/0032192, discloses a broad range of doped fluoride compositions prepared employing organic solutions at temperatures in the range of 200-250° C. 30 nm particles are disclosed. The organic solvent employed degrades and acts as a particle-size controlling surfactant.

Knowles-van Cappellen et al., Geochim. Cosmochim. Acta 61(9) 1871-1877 (1997), discloses preparation of 214±21 nm particles by combining in aqueous solution equal volumes of 0.1 M Ca(NO₃)₂ and 0.2 M of NaF. Knowles-van Cappellen is silent regarding doped particles.

The references teach methods for preparation of multi-valent fluorides, doped and undoped, with particle sizes in the range of about 2 to 500 nm. The teachings are confined to non-aqueous reaction media, or at least water/alcohol. The methods teach various means for controlling the particle size produced. For example, Bender teaches that higher concentrations of reactants lead to larger particles. Others show that the presence of a rare-earth dopant decreases particle size. Still others, Stouwdam, op.cit., and Haubold, op. cit., employ surfactants to control particle size.

It is desirable to have a method for controlling the size of metal fluoride nanoparticles in both doped and undoped compositions by avoiding to change the concentration of dopant and/or adding additional chemicals such as surfactants. The present invention fulfills this desire.

### SUMMARY OF THE INVENTION

The invention is directed to a method comprising, combining an aqueous solution of a fluoride selected from the group consisting of alkali metal fluorides, ammonium fluoride, hydrogen fluoride, and mixtures thereof at a concentration of 0.01 to 2 normal;
an aqueous solution of a host multi-valent metal salt at a concentration of 0.01 to 2 normal;
an aqueous solution of a rare-earth metal dopant wherein the absolute amount of the rare-earth being in the range of 0 to 25 mol-% of the molar concentration of said host multi-valent metal cation; and
forming a precipitate of an aqueously insoluble host multi-valent metal fluoride characterized by d50 particle size in the range of 2 to 500 nm and a dopant concentration of 0 to 25 mol-%, said host multi-valent metal fluoride being characterized by an aqueous solubility of less than 0.1 g/100 g of water; and
wherein increasing the concentration of at least one of the group selected from the aqueous solution of the fluoride or the host multi-valent metal salt within the concentration range achieves smaller particles; or
wherein decreasing the concentration of at least one of the group selected from the aqueous solution of the fluoride or the host multi-valent metal salt within the concentration range achieves larger particles.

### BRIEF DESCRIPTION OF THE DRAWINGS

FIG. 1 is an optical micrograph of the CaF₂ particles prepared in Example 1.

FIG. 2 is a transmission electron micrograph of the CaF₂ particles prepared in Example 2.

FIG. 3 is a transmission electron micrograph of the CaF₂ particles prepared in Example 3.

FIG. 4 shows the dynamic light scattering data for Examples 1-4.

### DETAILED DESCRIPTION

For the purposes of the present invention, the term “nanoparticles” shall be understood to refer to an ensemble of particles wherein at least 50% of the particles on a number basis (designated “d50”) are smaller than 500 nm in their largest dimension. Preferably, at least 50% of the particles on a number basis are found in the range of 2 to 500 nm in their largest dimension. The term “host multi-valent metal cation” refers to a cation which forms a host fluoride compound which is doped according to the process hereof with a rare earth dopant. The “host multi-valent metal cation” will be present as a soluble ion in the starting solution of the process hereof. “Host multi-valent metal salt” refers to an aqueously soluble starting salt of the process hereof; the cation of which is the host multi-valent metal cation. The term “rare-earth” refers to the members of the Lanthanide Series in the periodic table, namely La, Ce, Pr, Nd, Pm, Sm, Eu, Gd, Tb, Dy, Ho, Er, Tm, Yb, and Lu.

In one embodiment, a method is provided for controlling the size of undoped multi-valent metal fluorides. When there is no dopant, the term “host multi-valent metal” whether in relation to an aqueously soluble salt, the solution thereof, the cation of that salt, and the fluoride which results from the process hereof shall be understood to refer respectively to an aqueously soluble multi-valent metal salt, the solution thereof, the cation of that salt, and the fluoride which results according to the process hereof.

The present invention discloses a breakthrough in the technology of preparing rare-earth-doped or undoped host multi-valent metal fluoride nanoparticles in the desired size range. It is conveniently conducted by adjusting the concentrations of simple salts combined in aqueous solution at room temperature, and separation of the product by ordinary means known in the industry. Nanoparticles of host multi-valent fluorides, rare-earth-doped and undoped, have broad utility in many fields where the small size reduces light scattering and haze, and, in the case of doped particles, wherein the particles exhibit luminescence and may be useful for the formation of lasers, optical displays, and optical amplifiers. Applications include use in forming optical components, such as lenses, and windows.

The nanoparticles produced by the method comprise a rare-earth-doped or undoped crystalline or semi-crystalline host multi-valent metallic fluoride characterized by an aqueous solubility of less than 0.1 g/100 g of water and a particle size in the range of 5 to 500 nm.

According to the process aqueous solutions of a soluble fluoride and a soluble host multi-valent metal salt, and, optionally, an aqueously soluble rare-earth salt are combined at room temperature to produce a highly insoluble, optionally rare-earth-doped, host multi-valent metal fluoride. The reaction in aqueous solution of the soluble fluoride with the soluble host multi-valent metal cation is virtually instantaneous. The low solubility of the host multi-valent fluoride salt thereby produced is the key to the utility of the process. Precipitation occurs so quickly in the process of the invention that there is little time for crystal growth before precipitation.

According, an aqueous solution of a fluoride selected from the group alkali metal fluorides, ammonium fluoride, hydrogen fluoride, and mixtures thereof at a concentration in the range of 0.01 normal to 2 normal is combined with an aqueous solution of a host multi-valent metal salt, consisting essentially of a host multi-valent metal cation and an anion, at a concentration in the range of 0.01 to 2 normal, and optionally an aqueously soluble rare-earth dopant salt at a concentration in the range of 0.01 to 2 normal with the proviso that the absolute amount of the rare-earth dopant cation lie in the range of 0 to 25 mol-% and preferably 0.1 to 25 mol % of the concentration of the host multi-valent host metal cation. The particles formed will be rare-earth-doped or undoped host multi-valent metal fluorides characterized by a particle size such that 50 volume % (d50) of the particles are in the range of 2 to 500 nm.

More particularly, a concentration of reactants will be selected consistent with the general guidelines that concentrations of 0.2 to 0.01 normal will be associated with production of particles characterized by d50 in the range of about 100 to 500 nm, while concentrations in the range of 0.8 normal to 0.2 normal will be associated with production of particles characterized by d50 in the range of about 20 to 100 nm. After the first reaction is run, and the value of d50 determined for the particles so prepared is compared to a target value of d50, the practitioner may alter the concentration of one or more starting materials, preferably all in order to maintain the proper stoichiometric ratio, to more closely approximate the desired value of d50. The concentration will be increased to achieve smaller values of d50 and the concentration will be decreased to achieve higher values of d50. A target value for d50 will be determined by the particular requisites of the application intended for the particles produced.

The actual value of d50 which will be realized for any given concentration of starting ingredients depends upon the reaction criteria. Factors which affect the value of d50 at a fixed concentration level are: the chemical identity of the reactants, the presence and concentration of dopant, and the solubility of the host multi-valent metal fluoride salt. Thus, in the practice of the invention, it may be necessary to make several small adjustments to concentrations of the specific starting materials in order to zero-in on the desired particle size for the given host multi-valent metal fluoride at the given dopant level.

Depending upon the particular use to which the nanoparticles are intended, d50 will need to be determined with varying degrees of precision. In many embodiments, it is only necessary that an upper bound for the value of d50 be determined, and so long as that upper bound is below some pre-established maximum value, further precision is not required. For example, light scattering methods such as photon correlation spectroscopy, are unable to distinguish actual particle size from aggregates of particles, thus giving considerable weight to large agglomerates, and, as a result, producing a value for d50 which exhibits error on the high side. If the pre-established maximum value for d50 were 200 nm, and a light scattering result showed d50 to be less than 200 nm, that would suffice to establish that the particles in hand meet the requirements of the application, and no further precision would be needed. In other instances, d50 may be estimated by visual inspection of electron micrographs. Higher precision can be obtained using statistical image analysis techniques on the same micrographs.

The host multi-valent metal cation of the host multi-valent metal salt may be any multi-valent metal cation derived from alkaline earth and transition metals. Any such host multi-valent metal cation may be employed in the process with the proviso that the corresponding host multi-valent metal fluoride so produced is characterized by an aqueous solubility of less than 0.1 g/100 g at room temperature.

Aqueous solubilities of inorganic fluorides are available from a number of sources, including the well-known CRC Handbook of Chemistry and Physics, 8^{th} Edition. Fluorides which as are listed as having solubility below 0.1 g/100 g water or indicated to be “insoluble” in water are suitable for employment in the method of the invention. Many transition metal fluorides are soluble in water, and many are reactive with water, and are therefore not suitable for use.

Suitable host multi-valent metal cations for use in the present invention include but are not limited to Ca⁺², Mg⁺², Sr⁺², Y⁺³, La⁺³, Ac⁺³, Cr⁺³, Mo⁺³, Ir⁺³, Cu⁺², Ga⁺³ and Pb⁺², as well as the, rare-earths Ce⁺³, Nd⁺³, Eu⁺³, Er⁺³, Yb⁺³, and Lu⁺³. Rare-earths are frequently employed as dopants in the art, and the numerous host multi-valent metal fluorides prepared according to the process herein may be subject to doping by incorporating a soluble rare-earth salt into the reaction mixture. However, the rare-earths recited above are not dopants but serve as alternative host multi-valent metal cations, subject to the limitations of the process, namely that the resulting fluoride salt must have a solubility less than 0.1 g/100 ml of water. While all rare-earths are suitable to use as dopants, only those recited above are suitable to use as the host multi-valent cations in the method of the present invention.

Preferred anions for the soluble host multi-valent metal salt are chloride, nitrate, sulphate, acetate, hydroxide, phosphate, carbonate, and bromide. Preferably the aqueously soluble fluoride is NaF, KF, or NH₄F, most preferably NH₄F. Preferably, the host multi-valent metal cation is Ca⁺² in the form of CaCl₂, Ca(NO₃)₂, or CaSO₄. In the embodiment, the concentration of Ca⁺² is in the range of 0.01 to 2 normal, and the concentration of NaF is 0.01 to 2 normal. Preferably, equal normalities of the fluoride and the host multi-valent cation are employed. Preferably the reactants are combined in stoichiometric quantities.

It is observed in the practice of the invention, that use of an alkali metal fluoride in combination with certain host multi-valent metal cations may result in a mixture of fluorides. This problem can be remedied by employing NH₄⁺ in place of an alkali metal in the process. For that reason NH₄F is a preferred starting material if there is any question about undesirably contaminating the pure fluoride with the alkali-containing contaminant.

The soluble salt starting materials need only be soluble enough to form aqueous solutions of the desired concentrations for the purposes of the present invention. From the standpoint of the present invention, a salt is said to be aqueously soluble if a solution of the desired concentration can be formed from it.

In the typical practice of the invention, the ingredients are combined together in the space of a few minutes, and then allowed to react while being stirred for about 30 minutes. The pH of the reaction mixture is preferably maintained close to neutral but a pH range from about 1-11 is acceptable. Following reaction, the product may be conveniently separated by centrifugation and decanting of the supernatant liquid. The isolated “wet cake” so produced may then be redispersed in water (or organic solvents by a solvent exchange process) by mixing with liquid and subjecting the mixture to ultrasonic agitation for a period of 5-30 minutes. The dispersed particles are well-suited to use in coatings and the like. For dispersion in non-polar solvents, it may be required to combine the particles produced by the process with surfactants, as taught in the art.

Other suitable methods of separating the precipitate include ion exchange, dialysis and electrodialysis to get rid of salts produced in the process. Further methods, to separate and concentrate the sample, include evaporation of water, centrifugation, ultrafiltration, electrodecantation. A preferred procedure is to employ ion exchange resins to remove soluble salt residues followed by evaporation to concentrate the colloidal sol produced in the process.

It is preferred that when a rare-earth dopant is employed the aqueously soluble rare-earth dopant salt and the aqueously soluble host multi-valent metal salt be combined together before the mixture formed therefrom is combined with the aqueously soluble fluoride.

The reaction may be effected batch-wise or continuously. In a batch process, the solutions of the host multi-valent metal salt and any rare-earth dopant salt are first mixed together, and the reactant mixture so prepared is then combined in a vessel with the soluble fluoride salt reactant suitable for the practice of the invention, preferably while stirring. In a continuous process, the rare-earth dopant and host multi-valent metal salts are combined to form a first continuous feed stream and the soluble fluoride solution forms a second continuous feed stream. The two feed streams are fed continuous and simultaneously to a mixing chamber wherein they are vigorously mixed followed by discharge to a separation stage wherein the precipitate formed is separated by means herein described, or any means conventionally employed in the art for separating a fine precipitate from a suspension.

It is preferred that the nanoparticles prepared in the process of the invention be subject to water washing in order to remove any residual water soluble starting materials. Dispersing in water followed by centrifugation is one effective method.

In the process of the present invention it is preferred to combine the dopant rare earth salt and the host multi-valent metal salt before combining with the fluoride. The combination of the mixed salts with the fluoride may be effected by slowly adding the mixed salt solutions to the fluoride solution over period of several minutes, or rapidly combining the solutions, in less than a minute. The combination may be effected in a vessel, or it may be effected on a continuous feed basis to a mixing chamber. Any difference in result attributable to whether the dopant rare-earth and host multi-valent metal mixed salt solution is added to the fluoride solution, or the fluoride solution is added to the mixed salt solution appears to be negligible.

### EXAMPLES

In the following examples, NaF was obtained in solid form from J. T. Baker Reagents. CaCl₂.2H₂O was obtained from EM Sciences. MgCl₂.6H₂O was obtained from EMD. All other reagents were obtained from Aldrich Chemical Company.

### Example 1

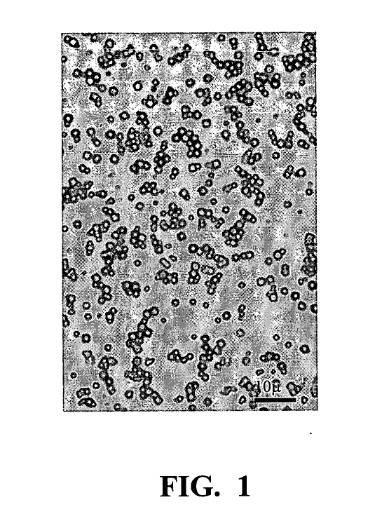

45 ml of 0.02 M NaF aqueous solution was added to a 250 ml polycarbonate flask. The solution was stirred using a magnetic stirring bar. 50 ml of 0.01 M CaCl₂ was added to the NaF with vigorous stirring. The mixture was stirred for 10 min. Precipitation was observed. A small amount of precipitate was examined using a Nikon Optical Microscope equipped with a digital camera. The crystal size of CaF₂ particle was in the range of 1-3 micrometers as shown in FIG. 1. D50 was clearly greater than 500 nm.

### Example 2

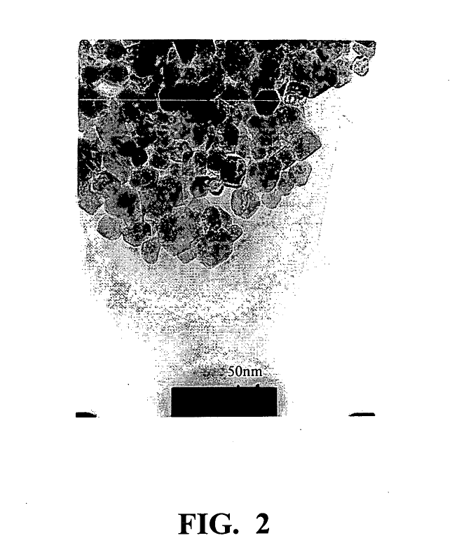

45 ml of 0.2 M NaF aqueous solution was added to a 250 ml polycarbonate flask. The solution was stirred using a magnetic stirring bar. Into the same flask, 50 ml of 0.1 M CaCl₂ was added to the NaF with vigorous stirring. A CaF₂ colloidal sol was formed. The mixture was stirred for 30 min. A small amount of the colloidal suspension was then diluted with de-ionized water and analyzed by transmission electron microscopy (TEM). The TEM image showed the crystal size of the CaF₂ particles prepared in this example is in the range of 50-200 nm (FIG. 2). By visual inspection, d50 was in the range of 100-150 nm.

### Example 3

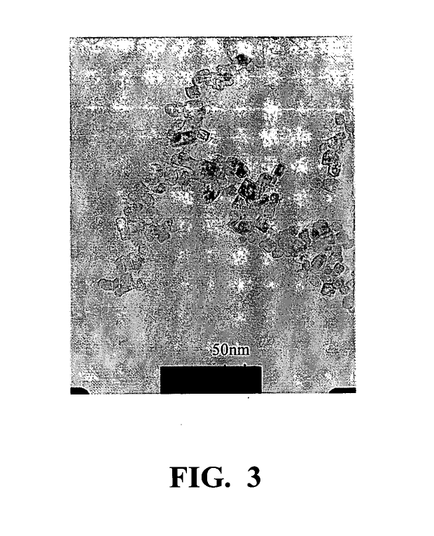

50 ml of 0.8 M NaF aqueous solution was added to a 250 ml polycarbonate flask. The solution was stirred using a magnetic stirring bar. 50 ml of 0.4 M CaCl₂ was added to the NaF with vigorous stirring. The addition was completed in three minutes. A CaF₂ colloidal sol was formed. The sol was stirred for 30 min. A small amount of the colloidal sol was diluted 30 times with de-ionized water and analyzed by TEM. The TEM image showed that the crystal size of the CaF₂ nanoparticles thus prepared were in the range of 20˜70 nm (FIG. 3). By visual inspection of the micrograph, d50 was estimated to be 45 nm.

### Example 4

0.3 M CaCl₂ solution was mixed with 0.3 M TbCl₃ solution in a 250 ml polycarbonate flask, in the amounts shown in Table 3. The thus mixed solution was then poured with vigorous stirring into a 500 ml polycarbonate flask containing 0.6 M NaF solution.

TABLE 3

| | | | 0.3 M | |
|---|---|---|---|---|
| | | | TbCl₃ | 0.6 M NaF |
| | | 0.3 MCaCl₂ | solution | solution |
| | Tb % | solution (ml) | (ml) | (ml) |
| Ex. 4 | 0 | 80 | 0 | 80 |
| Ex. 1 | 2 | 98 | 2 | 101 |
| Ex. 2 | 5 | 95 | 5 | 102.5 |
| Ex. 3 | 10 | 90 | 10 | 105 |

The addition of the metal chloride solutions into the sodium fluoride solution was completed in 30˜60 seconds. The resulting colloidal suspension was stirred for 2 min followed by ultrasonic agitation for 30 min using a Branson 1510 ultrasonic bath. The colloidal sols were aged for 2˜3 hr and then centrifuged at 7500 rpm for 35 min. The supernatant liquid was decanted. The residual wet cake was then divided into two parts.

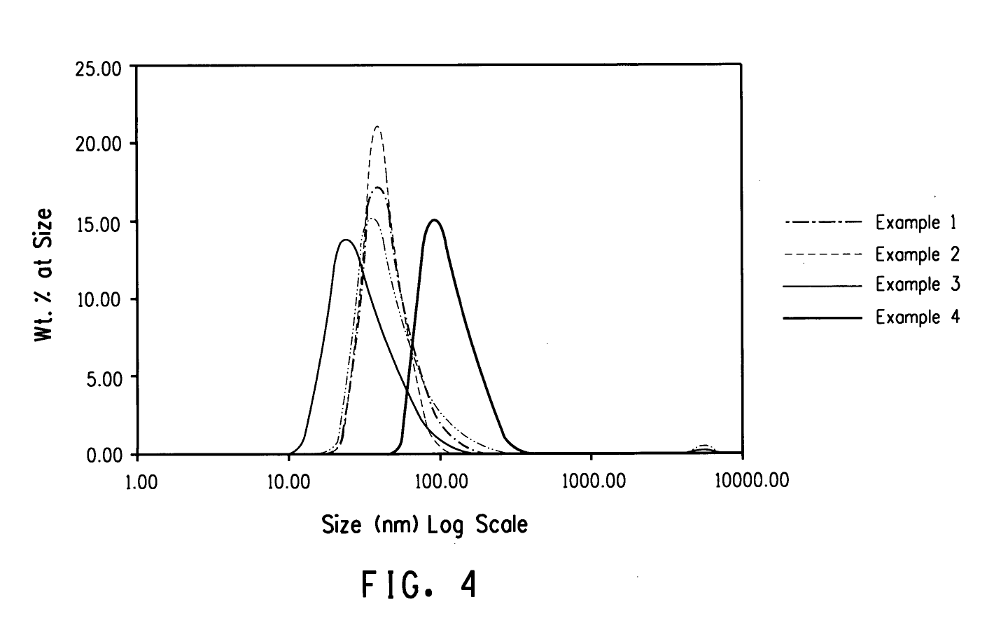

Half of the wet cake was transferred into a 50 ml plastic tube. Deionized water was added to make up a final volume of 45 ml. The mixture was then ultrasonically agitated with a micro-tip unitrasonic probe (VibraCell, Sonics & Material, Danbury, Conn., USA) for 3 min. The cake was nicely dispersed in de-ionized water after sonication. Particle size distribution of the resulting dispersed sol was determined by dynamic light scattering using a Zetasizer® Nano-S. Just prior to measurement, each specimen was subject to additional ultrasonic agitation for 2 min using the egular-tip (half inch) ultrasonic probe of the VibraCell®. Results are listed in following Table 4 and depicted in FIG. 4.

TABLE 4

| | d50 (nm) |
|---|---|
| Ex. 4 | 109.9 |
| Ex. 1 | 43.4 |
| Ex. 2 | 40.2 |
| Ex. 3 | 30.2 |

We claim:

1. A method comprising combining
an aqueous solution of a fluoride selected from the group consisting of alkali metal fluorides, ammonium fluoride, hydrogen fluoride, and mixtures thereof at a concentration of 0.01 to 2 normal;
an aqueous solution of a host multi-valent metal salt at a concentration of 0.01 to 2 normal;
an aqueous solution of a rare-earth metal dopant wherein the absolute amount of the rare-earth being in the range of 0 to 25 mol-% of the molar concentration of said host multi-valent metal cation; and
forming a precipitate of an aqueously insoluble host multi-valent metal fluoride characterized by d50 particle size in the range of 2 to 500 nm and a dopant concentration of 0 to 25 mol-%, the host multi-valent metal fluoride being characterized by an aqueous solubility of less than 0.1 g/100 g of water; and
wherein increasing the concentration of at least one of the group selected from the aqueous solution of the fluoride or the host multi-valent metal salt within the concentration range achieves smaller particles; or
wherein decreasing the concentration of at least one of the group selected from the aqueous solution of the fluoride or the host multi-valent metal salt within the concentration range achieves larger particles.

2. The method of claim 1 wherein the multi-valent cation is selected from the group consisting of Ca⁺², Mg⁺², Sr⁺², Y⁺³, La⁺³, Ac⁺³, Cr⁺³, Mo⁺³, Ir⁺³, Cu⁺², Ga⁺³, Pb⁺², Ce⁺³, Nd⁺³, Eu⁺³, ER⁺³, Yb⁺³, and Lu⁺³.

3. The method of claim 2 wherein the host multi-valent metal cation is selected from the group consisting of Ca⁺² or La⁺³.

4. The method of claim 1 wherein the aqueous solution of a fluoride is an aqueous ammonium fluoride solution.

5. The method of claim 1 further comprising dilution in water and ultrasonic agitation.

6. The method of claim 1 wherein the normality of the aqueous fluoride and host multi-valent metal salt solutions are equal.

7. The method of claim 1 wherein the aqueous fluoride and host multi-valent metal salt solutions are combined in stoichiometric amounts.

8. The method of claim 1 further comprising a sequence of reactions in which the concentrations of the aqueous fluoride solution is varied in order to achieve a desired particle size.

9. The method of claim 1 further comprising a sequence of reactions in which the concentrations of the host multi-valent metal salt solution is varied in order to achieve a desired particle size.

10. The method of claim 1 further comprising a batch process wherein the reaction mixture is formed in a vessel.

11. The method of claim 1 further comprising a continuous process wherein the reaction mixture is formed in a mixing chamber fed by continuous feed streams of reactants.

12. The method of claim 1 wherein the aqueous solution of a host multi-valent metal salt consists essentially of a host multi-valent metal cation and an anion.
